(19) United States
(12) Patent Application Publication
(10) Pub. No.: US 2025/0005485 A1
(43) Pub. Date: Jan. 2, 2025

(54) A PERFORMANCE-FOCUSED SIMILARITY ANALYSIS PROCESS UTILIZING GEOLOGICAL AND PRODUCTION DATA

(71) Applicant: SAUDI ARABIAN OIL COMPANY, Dhahran (SA)

(72) Inventors: Nikita Bukhanov, Moscow (RU); Sergey Safonov, Moscow (RU); Klemens Katterbauer, Dhahran (SA); Abdallah Alshehri, Dhahran (SA)

(73) Assignees: SAUDI ARABIAN OIL COMPANY, Dhahran (SA); Aramco Innovations LLC, Moscow (RU)

(21) Appl. No.: 18/710,876

(22) PCT Filed: Oct. 26, 2022
(86) PCT No.: PCT/RU2022/000323

§ 371 Date: May 16, 2024

(51) Int. Cl. G06Q 10/0633; G06Q 50/02

(52) U.S. Cl. CPC G06Q 10/0633; G06Q 50/02

(57) ABSTRACT

A method to perform a field operation based on similarity of wells in a field is disclosed. The method includes generating, based on well log data files, a geology related similarity score for each pair of wells, generating, based on production data files, a production related similarity score for said each pair of wells, generating, by combining the geology related similarity score and the production related similarity score, a combined similarity score of said each pair of wells, determining, by aggregating the combined similarity score of said each pair of wells, an aggregate similarity score of each well, and facilitating, based at least on the aggregate similarity score of each well, the field operation in the field.

### BACKGROUND

In oil and gas industry, the term “production data” refers to amount of hydrocarbon output recorded on a periodic basis as a time series, which is a set of historical data points that are associated with time stamps. The term “well log” refers to measurement versus depth of geological properties in or around a well. The term comes from the word “log” used in the sense of a record or a note. Wireline logs are obtained downhole and transmitted through a wireline to surface and recorded. For example, wireline logs include measurements-while-drilling (MWD) and logging while drilling (LWD) logs.

### SUMMARY

In general, in one aspect, the invention relates to a method to perform a field operation based on similarity of wells in a field. The method includes generating, based on well log data files of the wells, a geology related similarity score for each pair of wells with respect to a well log depth range of a plurality of well log depth ranges, generating, based on production data files of the wells, a production related similarity score for said each pair of wells with respect to a production time stamp range of a plurality of production time stamp ranges, generating, by combining the geology related similarity score and the production related similarity score, a combined similarity score of said each pair of wells with respect to the well log depth range and the production time stamp range, determining, by aggregating the combined similarity score of said each pair of wells with respect to the plurality of well log depth ranges and the plurality of production time stamp ranges, an aggregate similarity score of said each pair of wells, and facilitating, based at least on the aggregate similarity score of said each pair of wells, the field operation in the field.

In general, in one aspect, the invention relates to a data gathering and analysis system. The data gathering and analysis system includes a computer processor and memory storing instructions, when executed, causing the computer processor to generate, based on well log data files of the wells, a geology related similarity score for each pair of wells with respect to a well log depth range of a plurality of well log depth ranges, generate, based on production data files of the wells, a production related similarity score for said each pair of wells with respect to a production time stamp range of a plurality of production time stamp ranges, generate, by combining the geology related similarity score and the production related similarity score, a combined similarity score of said each pair of wells with respect to the well log depth range and the production time stamp range, generate, by aggregating the combined similarity score of said each pair of wells with respect to the plurality of well log depth ranges and the plurality of production time stamp ranges, an aggregate similarity score of said each pair of wells, and facilitate, based at least on the aggregate similarity score of said each pair of wells, the field operation in the field.

In general, in one aspect, the invention relates to a system that includes a plurality of wells penetrating a subterranean formation in a field, and a data gathering and analysis system comprising functionality for generating, based on well log data files of the wells, a geology related similarity score for each pair of wells with respect to a well log depth range of a plurality of well log depth ranges, generating, based on production data files of the wells, a production related similarity score for said each pair of wells with respect to a production time stamp range of a plurality of production time stamp ranges, generating, by combining the geology related similarity score and the production related similarity score, a combined similarity score of said each pair of wells with respect to the well log depth range and the production time stamp range, generating, by aggregating the combined similarity score of said each pair of wells with respect to the plurality of well log depth ranges and the plurality of production time stamp ranges, an aggregate similarity score of said each pair of wells, and facilitating, based at least on the aggregate similarity score of said each pair of wells, the field operation in the field.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A and 1B show a system in accordance with one or more embodiments.

FIG. 2 shows a data flow diagram in accordance with one or more embodiments.

FIG. 3 shows a workflow diagram in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for performing a field operation as facilitated by ranking similarity among wells in the field. In one or more embodiments, details in the hydrocarbon formation structure and special distribution of subsurface reservoir properties in the field are generated, or otherwise explored, by analyzing the similarity between patterns of the same petrophysical (geology related) and production (hydrocarbon output related) properties in different wells. Specifically, a subsurface reservoir corresponds to a complex interconnected system of multiple rock and fluid systems, each of which contains hydrocarbons, water and gas and is referred to as an analogous portion of the field or reservoir. In this complex interconnected system, a well corresponds to an element that has a number of important attributes. These attributes may include well survey geometry, geological features across depth, production history and well construction and completion configurations (i.e., structural designs).

In one or more embodiments, a performance-focused similarity analysis is performed utilizing geological and production data. The similarity analysis integrates various subsurface data, such as local reservoir geology, and well completion information for individuals well, and then follows a workflow to calculate a similarity score for the wells. Based on feature engineering and deep learning, the similarity between these features is determined, and subsequently the production data are also analyzed and their similarity is computed. The geology related similarity score and the production related similarity score are then joined with each other to compute an overall similarity score as well as determine the relationships and interconnectedness between the wells. Wells are clustered based on respective similarity scores to form analogous and non-analogous portions of the reservoir.

In one or more embodiments, the production performances of different analogous portions and corresponding contributions to performance of overall reservoir formations are analyzed, evaluated, and ranked to generate regional clustering and machine learning (ML) models, which are used for facilitating field operation tasks, such as production forecast, well connectivity estimation, reservoir management optimization, etc.

In one or more embodiments, the similarity scores are used to form a new dataset of well log and production data. This new dataset is formed by selection of highly ranked wells by a joint similarity measure referred to as the aggregate similarity score. This dataset may not include all available wells associated with the well log and production data. Reducing number of wells by selection based on joint similarity ranking increases accuracy of machine learning tasks based on these wells. These selected wells are used for further training and testing new artificial intelligence (AI) models for prediction of well performance based on machine and deep learning algorithms.

In one or more embodiments, the similarity scores are used to enhance the search engine capabilities for well data using particular performance characteristics which are a combination of the similarities of geology and production related data from each well. The search engine works automatically for each well in the dataset with no need to specify any particular query by a geologist or petroleum engineer.

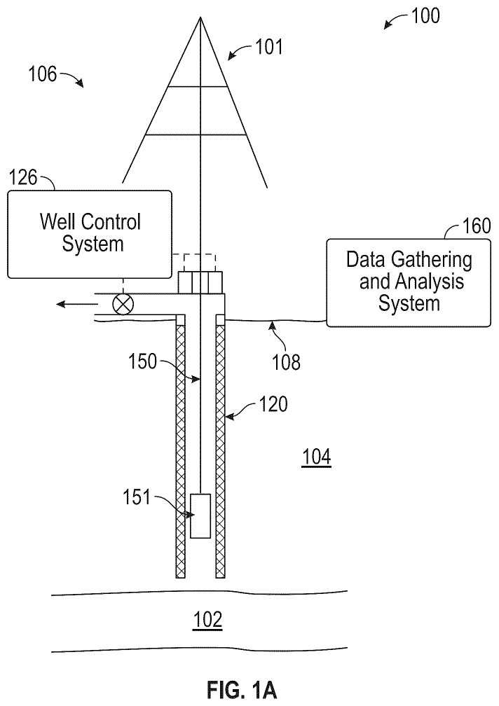

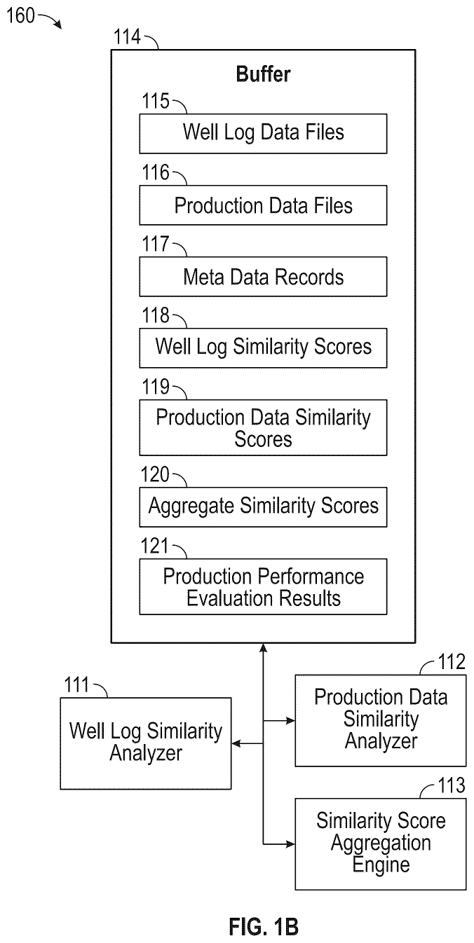

FIG. 1A shows a schematic diagram of a well environment in accordance with one or more embodiments. In one or more embodiments, one or more of the modules and/or elements shown in FIG. 1A may be omitted, repeated, and/or substituted. Accordingly, embodiments disclosed herein should not be considered limited to the specific arrangements of modules and/or elements shown in FIG. 1A.

As shown in FIG. 1A, a well environment (100) includes a subterranean formation (“formation”) (104) and a well system (106). The formation (104) may include a porous or fractured rock formation that resides underground, beneath the earth's surface (“surface”) (108). The formation (104) may include different layers of rock having varying characteristics, such as varying degrees of permeability, porosity, capillary pressure, and resistivity. In the case of the well system (106) being a hydrocarbon well, the formation (104) may include a hydrocarbon-bearing reservoir (102). In the case of the well system (106) being operated as a production well, the well system (106) may facilitate the extraction of hydrocarbons (or “production”) from the reservoir (102).

In some embodiments disclosed herein, the well system (106) includes a rig (101), a wellbore (120), a data gathering and analysis system (160), and a well control system (“control system”) (126). The well control system (126) may control various operations of the well system (106), such as well production operations, well drilling operation, well completion operations, well maintenance operations, and reservoir monitoring, assessment and development operations. In some embodiments, the well control system (126) includes a computer system.

The rig (101) is the machine used to drill a borehole to form the wellbore (120). Major components of the rig (101) include the drilling fluid tanks, the drilling fluid pumps (e.g., rig mixing pumps), the derrick or mast, the draw works, the rotary table or top drive, the drill string, the power generation equipment and auxiliary equipment. Drilling fluid, also referred to as “drilling mud” or simply “mud,” is used to facilitate drilling boreholes into the earth, such as drilling oil and natural gas wells.

In some embodiments, a bottom hole assembly (BHA) (151) is attached to the drill string (150) to suspend into the wellbore (120) for performing the well drilling operation. The bottom hole assembly (BHA) is the lowest part of the drill string (150) and includes the drill bit, drill collar, stabilizer, mud motor, etc.

The wellbore (120) includes a bored hole (i.e., borehole) that extends from the surface (108) towards a target zone of the formation (104), such as the reservoir (102). The wellbore (120) may be drilled for exploration, development and production purposes. The wellbore (120) may facilitate the circulation of drilling fluids during drilling operations for the wellbore (120) to extend towards the target zone of the formation (104) (e.g., the reservoir (102)), facilitate the flow of hydrocarbon production (e.g., oil and gas) from the reservoir (102) to the surface (108) during production operations, facilitate the injection of substances (e.g., water) into the hydrocarbon-bearing formation (104) or the reservoir (102) during injection operations, or facilitate the communication of logging tools lowered into the formation (104) or the reservoir (102) during logging operations. The wellbore (120) may be logged by lowering a combination of physical sensors downhole to acquire data that measures various rock and fluid properties, such as irradiation, density, electrical and acoustic properties. The acquired data may be organized in a log format and referred to as well logs or well log data. The wellbore (120) may be one of multiple wellbores throughout an area of the formation referred to as a field, e.g., an oil field. Field operations performed throughout the field includes, drilling operation, production operation, injection operation, logging operation, and other maintenance and management operations.

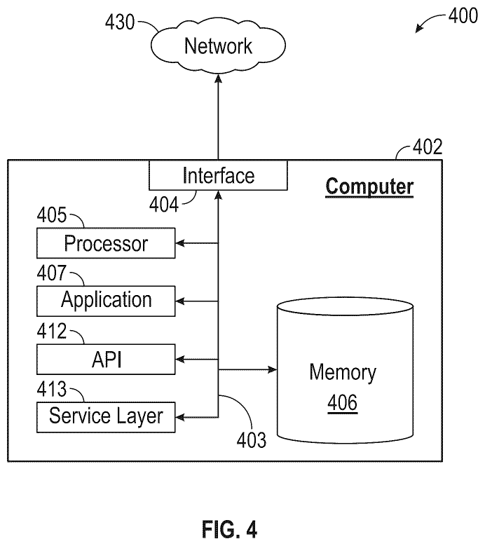

In some embodiments, the data gathering and analysis system (160) includes hardware and/or software with functionality for facilitating operations of the well system (106), such as well production operations, well drilling operation, well completion operations, well maintenance operations, and reservoir monitoring, assessment and development operations. For example, the data gathering and analysis system (160) may store drilling data records of drilling the wellbore (120), well log data records of logging the wellbore (120), and production data records of hydrocarbon production from the wellbore (120). The data gathering and analysis system (160) may analyze the drilling data records, the well log data records, and the production data records to generate recommendations to facilitate various operations of the well system (106). While the data gathering and analysis system (160) is shown at a well site, embodiments are contemplated where at least a portion of the data gathering and analysis system (160) is located away from well sites. In some embodiments, the data gathering and analysis system (160) may include a computer system that is similar to the computer system (400) described below with regard to FIG. 4 and the accompanying description.

FIG. 1B shows details of the data gathering and analysis system (160) depicted in FIG. 1A above, in accordance with one or more embodiments disclosed herein. In one or more embodiments, one or more of the modules and/or elements shown in FIG. 1B may be omitted, repeated, and/or substituted. Accordingly, embodiments disclosed herein should not be considered limited to the specific arrangements of modules and/or elements shown in FIG. 1B.

As shown in FIG. 1B, the data gathering and analysis system (160) has multiple components, including, for example, a buffer (114), a well log similarity analyzer (111), a production data similarity analyzer (112), and a similarity score aggregation engine (112). Each of these components is discussed below.

In one or more embodiments, the buffer (114) may be implemented in hardware (i.e., circuitry), software, or any combination thereof. The buffer (114) may be any data structure configured to store input data, output results, and intermediate data of the well log similarity analyzer (111), the production data similarity analyzer (112), and the similarity score aggregation engine (112). In one or more embodiments, the buffer (114) stores well log data files (115), production data files (116), meta data records (117), well log similarity scores (118), production data similarity scores (119), aggregate similarity scores (121), and production performance evaluation results (122).

The well log data files (115) include wireline logs, MWD logs, LWD logs, mud logs, etc. of wells in a field. Well logs are the result of multiple physical measurements performed by a wireline tool lowered into the wellbores to establish the petrophysical properties along the wellbore. In one or more embodiments, each of the well log data files (115) is mathematically represented as multivariate time series data where the time axis corresponds to the depth where the measurements are made along the trajectory of the wellbores. The well log data files (115) have specific complications comparing to conventional time series data, such as different value ranges and calibration rules for different wellbores logged using the same type of tools, multiple logging runs and empty sections of logs due to engineering problems, inequivalent representation of measurement values using different tools for the same petrophysical property, and natural uncertainty of measurements due to well construction design and complex structure of porous media saturated by various types of fluids.

The production data files (116) includes production data (e.g., hydrocarbon flow rates) in the time series format of the wells in the field. The production flow rates of produced fluids are usually measured by multiphase flow meters after the wells enter into the production phase. Each of the production data files (116) is associated with a well and includes uncertainty influence due to measurement techniques, interpretation methods, and human factors. In addition, the production time series data of the production data files (116) have specific complications, such as nonlinear dependencies, different time scales, time subsampling and aggregation, discrete data interpolation, and noise distributions.

The meta data records (117) include information about spatial distribution of wells by well heads coordinates, detailed plans of well surveys, representation format of inter-well space (e.g., cellular grid property), graph interconnections or clustered regions in the field, development scenario decisions, historical drilling sequence relating to dynamic nature of production data, etc.

The well log similarity scores (118) include a collection of well log similarity scores for the wells in the field based on petrophysical properties. Each well log similarity score represents a measure of similarity in two corresponding well log files of a pair of wells in the field. Each well log similarity score pertains to a particular petrophysical property and a particular depth range.

The production data similarity scores (119) include a collection of production data similarity scores for the wells in the field. Each production data similarity score represents a measure of similarity in two corresponding well production data files of a pair of wells in the field. Each production data similarity score pertains to a particular type of production data and a particular production time period (i.e., time stamp range in the time series data).

The aggregate similarity scores (121) include a collection of aggregate similarity scores for the wells in the field. Each aggregate similarity score corresponds to a combination of a well log similarity score and a production data similarity score of a pair of wells in the field. The combination of the well log similarity scores (118) and the production data similarity scores (119) is guided based on the meta data records (117). Each aggregate similarity score pertains to a particular petrophysical property, a particular depth range, and a particular production time period.

The production performance evaluation results (122) include a collection of measured and/or estimated individual performance (i.e., a measure of production output) of each well in the field and its contribution to overall field performance. In one or more embodiments, the production performance evaluation results (122) are generated at least based on the aggregate similarity scores (121) of the wells in the field.

In one or more embodiments, the well log similarity analyzer (111) may be implemented in hardware (i.e., circuitry), software, or any combination thereof. The well log similarity analyzer (111) is configured to generate the well log similarity scores (118) based on the well log data files (115).

In one or more embodiments, the production data similarity analyzer (112) may be implemented in hardware (i.e., circuitry), software, or any combination thereof. The production data similarity analyzer (112) is configured to generate the production data similarity scores (119) based on the production data files (116).

In one or more embodiments, the similarity score aggregation engine (113) may be implemented in hardware (i.e., circuitry), software, or any combination thereof. The similarity score aggregation engine (113) is configured to generate the aggregate similarity scores (121) based on the well log similarity scores (118) and the production data similarity scores (119).

Similarity of different parts of time series obtained from different sources and domains is essential and complex task to assess and evaluate individual performance of a well and its contribution in overall field performance. The evaluation may be performed separately to different data records before being combined into a common measure. High-dimensional yet sparse feature space of the well log data files (115) and the production data files (116) allow to implement metric approaches (e.g., Euclidean, Minkowski space, Mahalanobis distance, Dynamic Time Warping, etc.) as well as deep learning architectures (Long short-term memory, Graph neural networks, etc.). Dynamic characteristics of production time series data records and well log data records are analyzed using joint analysis at different time stamp ranges and different depth ranges. The individual well production performance and overall field production performance are assessed (i.e., evaluating historical performance and predicting future performance) throughout the lifetime of the field production based on the spatial-temporal nature of the joint analysis.

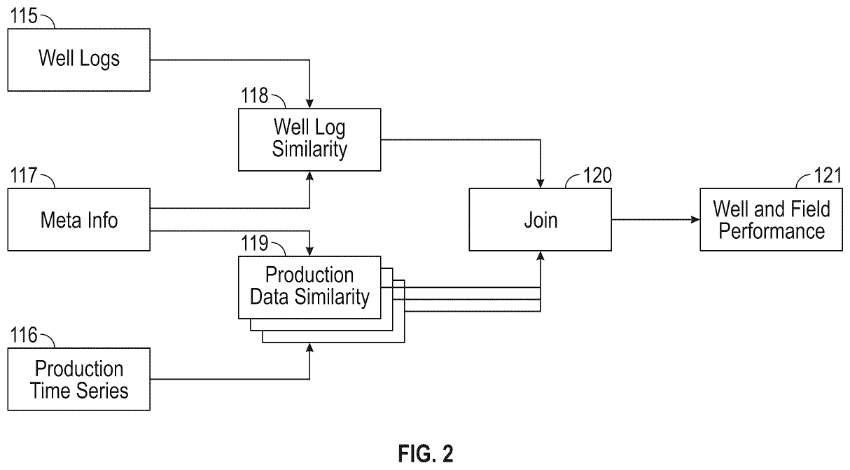

In one or more embodiments, the well log similarity analyzer (111), the production data similarity analyzer (112), and the similarity score aggregation engine (112) collectively perform the functionalities described above using the method described in reference to FIG. 2 below.

Although the data gathering and analysis system (160) is shown as having four components (111, 112, 113, 114), in other embodiments, the data gathering and analysis system (160) may have more or fewer components. Further, the functionality of each component described above may be split across multiple components. Further still, each component (111, 112, 113, 114) may be utilized multiple times to carry out an iterative operation.

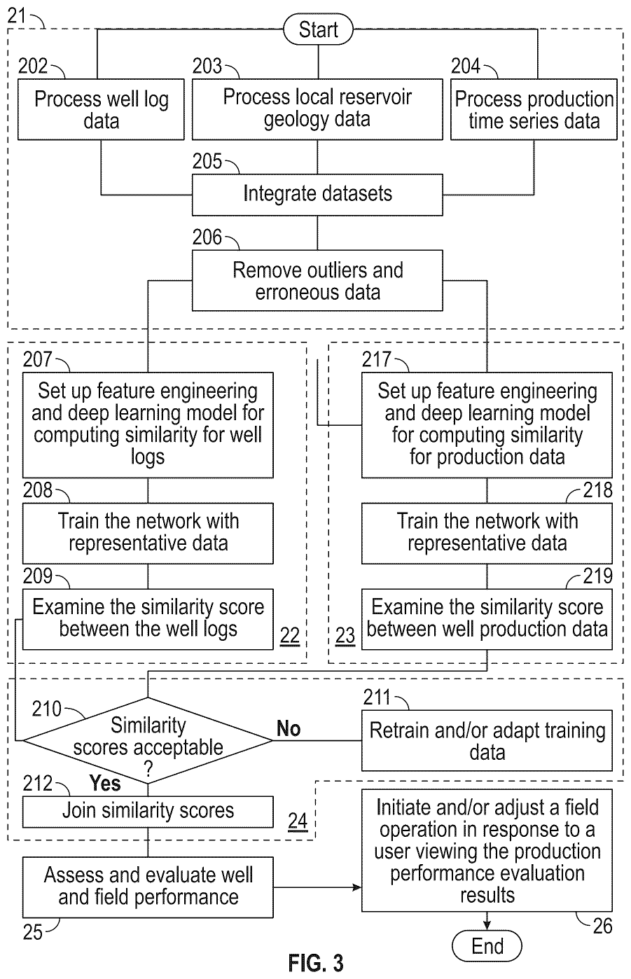

FIG. 2 shows a data flow diagram in accordance with one or more embodiments. The data flow diagram shown in FIG. 3 is based on the gathering and analysis system (160), discussed above in reference to FIG. 1B. In one or more embodiments, one or more of the modules and/or elements shown in FIG. 2 may be omitted, repeated, and/or substituted. Accordingly, embodiments disclosed herein should not be considered limited to the specific arrangements of modules and/or elements shown in FIG. 2.

As shown in FIG. 2, the well logs in the well log data files (115) and the meta data information in the meta data records (117) are used to generate the well log similarity scores (118). In addition, the production time series data in the production data files (116) and the meta data information in the meta data records (117) are used to generate the production data similarity scores (119). Well logs similarity scores (118) are depicted with a single block because this similarity is uniquely identified although it can be calculated with different input data. Production data similarity scores (119) are depicted with multiple blocks because this similarity has different interpretations depending on what input data was used for calculation. The well log similarity scores (118) and the production data similarity scores (119) are then joined to generate the aggregate similarity scores (121). Accordingly, the production performance evaluation results (122) are generated based at least on the aggregate similarity scores (121). Further details of the data flow diagram shown in FIG. 2 are illustrated in FIG. 3 below.

FIG. 3 shows a flowchart of a workflow in accordance with one or more embodiments disclosed herein. One or more of the elements in FIG. 3 may be performed by the components of the well environment (100), in particular the data gathering and analysis system (160), discussed above in reference to FIGS. 1A-1B. In one or more embodiments, one or more of the modules and/or elements shown in FIG. 3 may be omitted, repeated, and/or performed in a different order than the order shown in FIG. 3. Accordingly, the scope of the disclosure should not be considered limited to the specific arrangement of modules and/or elements shown in FIG. 3.

Referring to FIG. 3, initially in Block 21, well log data, local reservoir geology data, and production time series data are processed and integrated. The well log data is processed in sub-block 202 where the well log data is adjusted according to different types of tools, normalization rules and vertical interpretation results at various levels (e.g., stratigraphy, formation, lithology). The local reservoir geology data is processed in sub-block 203 to be used as meta data in later part of the workflow, which includes well coordinates, deviation surveys, representation of inter-well space, development scenarios, drilling history, regional geology, etc. The production time series data is processed in sub-block 204 where the production data is adjusted according to aggregation parameters (e.g., rates, pressure, total) for well, cluster or field within time scale of days, months and years. These processed data set are integrated into very high-dimensional but sparse matrices or tensors in sub-block 205. This means that each well has a large number of features (i.e., high-dimensional) but each feature is represented with a limited number of values (i.e., sparse). In addition, outliers and erroneous data are removed in sub-block 206.

In Block 22, a similarity method for well log is performed where feature engineering and deep learning model are set up within a chosen depth range (e.g., chosen based on stratigraphic interval of analysis) in sub-block 207. Feature engineering is the act of converting raw observations into desired features using statistical or machine learning approaches. A “feature” is any measurable input that can be used in a machine learning model. More specifically, feature engineering is the process of selecting, manipulating, and transforming raw data into features to be used by supervised machine learning algorithms. For well logs similarity, features are primarily log measurements (e.g., Gamma Ray, Density, Sonic data).

Deep learning model is a neural network based machine learning model that is trained in sub-block 208 using the processed well log data and meta data from Block 21 above. Using the neural network, a geology related similarity score between well logs is generated and examined in sub-block 209.

In one or more embodiments, the well logs similarity is generated based on distance measures. Distance measures are normalized and used as similarity features. In alternative embodiments, the well logs similarity is generated based on deep learning models in combination with feature engineering and selection, anomalies or novelty detection. The feature selection process focuses on evaluating the influence of each feature for the model output. Anomalies and novelty detection are methods for identifying samples with the most dissimilarity, which also allow to define the other samples as similar.

In Block 23, a similarity method for production time series is performed where feature engineering and deep learning model are set up within a chosen time step range in sub-block 217. Features used for production similarity may include time series of fluid rates, bottom hole pressure, and/or water cut. Time steps for analysis are defined according to time period of interest; therefore, it is essential to use time series with equal period of observation. Another neural network is trained in sub-block 218 using the processed production time series data and meta data from Block 21 above. Using the neural network, a production data related similarity score between wells is generated and examined in sub-block 219.

In Block 24, the geology related similarity score and the production data related similarity score are determined to be acceptable or not based on sub-blocks 209 and 219 above. If they are not acceptable, the neural network is retained and/or the processed data from Block 21 is adapted to improve the training data for the neural network in sub-block 211. If the geology related similarity score and the production data related similarity score are acceptable, then they are joined (i.e., combined) to generate the aggregate similarity scores in sub-block 212.

In one or more embodiments, joining of the geology related similarity score and the production data related similarity score is by combination of similarity weights, rating lists for wells, multiplex dynamic graph update, or graph neural networks link prediction. Similarity weights for geology and production may be summarized and normalized to perform joining of similarity scores. Rating lists for wells based on geological and production similarity may be combined by co-occurrence of wells in both lists. Multiplex graph update assumes that geological and production pair-wise similarities form separate graphs which are interconnected with each other. The Graph Neural Network is trained using production similarity graphs with well logs as features on each node. The combined geology related similarity score and production data related similarity score is referred to as a combined similarity score.

In one or more embodiments, each combined similarity score is specific to a chosen depth range and a chosen time step range of a pair of wells. In this context, the combined similarity score represents a measure of similarity between the two wells with respect to the geology in the chosen depth range and the production data in the chosen time step range. Across the field, the aggregate similarity scores are the collection of combined similarity scores between all pairs of wells with respect to all well log depth ranges and production data time stamp ranges for each pair of wells. Evaluation of the performance criteria of individual wells and its contribution to overall reservoir performance is based on assigning an aggregated similarity score to each well and ranking of wells by combined geology and production related similarity scores. Aggregated similarity is defined by means of average pair-wise similarity coefficients of target well with all the others based on well logs and production profiles.

In Block 25, well and field production performances are assessed and evaluated based on aggregate similarity scores. In one or more embodiments, evaluation of the performance of individual wells and its contribution to overall reservoir performance is based on assigning an aggregate similarity score to each well and ranking of wells by combined geology and production related similarity scores. The aggregate similarity score of an individual well (referred to as a target well) is an average of pair-wise similarity scores of the target well with all the other wells in the field.

In one or more embodiments, evaluation of the performance of individual wells and its contribution to overall reservoir performance is based on regional clustering and machine learning (ML) models to generate production performance evaluation results. In one or more embodiments, the wells in the field are clustered based at least on the aggregate similarity scores. In addition, the clustering may also be based on inter-well space and well connectivity evaluation. Each well cluster includes wells that have high combined similarity scores between each other, are close to each other, and exhibit high connectivity between each other. For example, each combined similarity score in the aggregate similarity scores of a single cluster exceeds a pre-determined similarity threshold. In addition, all wells in a single cluster are within a pre-determined distance from each other, and have a connectivity measure between each other exceeding a pre-determined connectivity threshold. In this context, each well cluster is referred to as an analogous portion of the field. Accordingly, the wells throughout the field are divided into multiple analogous portions (i.e., well clusters). In one or more embodiments, different analogous portions (i.e., well clusters) and corresponding contributions to performance of overall reservoir formations are ranked based on the production output performance (i.e., total hydrocarbon flow rates) of each well cluster. Specifically, different analogous portions and corresponding contributions to performance of overall reservoir formations are analyzed, evaluated, and ranked to generate the regional clustering and machine learning (ML) models of the well and field production performance.

In Block 26, the regional clustering and machine learning (ML) models from Block 25 are used to facilitate field operation tasks, such as production forecast, well connectivity estimation, reservoir management optimization, etc. For example, a field operation, such as a drilling operation, production operation, injection operation, logging operation, and other maintenance and management operations may be initiated and/or adjusted in response to a user viewing the production performance evaluation results from Block 25. For example, the user may choose a location to drill a new well based on the well locations of a well cluster that is indicated in the production evaluation results as having the highest production performance.

Embodiments may be implemented on a computing system. FIG. 4 depicts a block diagram) of a computing system (400) including a computer (402) used to provide computational functionalities associated with described machine learning networks, algorithms, methods, functions, processes, flows, and procedures as described in this disclosure, according to one or more embodiments. The illustrated computer (402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or another suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols, such as the Wellsite Information Transfer Specification (WITS) protocol, associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing a computer (402), wherein each computer (402) communicates over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

While the invention has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed:

1. A method to perform a field operation based on similarity of wells in a field, comprising:
generating, based on well log data files of the wells, a geology related similarity score for each pair of wells with respect to a well log depth range of a plurality of well log depth ranges;
generating, based on production data files of the wells, a production related similarity score for said each pair of wells with respect to a production time stamp range of a plurality of production time stamp ranges;
generating, by combining the geology related similarity score and the production related similarity score, a combined similarity score of said each pair of wells with respect to the well log depth range and the production time stamp range;
determining, by aggregating the combined similarity score of said each pair of wells with respect to the plurality of well log depth ranges and the plurality of production time stamp ranges, an aggregate similarity score of said each pair of wells; and
facilitating, based at least on the aggregate similarity score of said each pair of wells, the field operation in the field.

2. The method of claim 1, further comprising:
generating, using a feature engineering technique, a plurality of well log feature vectors from the well log data files,
wherein the geology related similarity score is generated by applying a machine learning algorithm to the plurality of well log feature vectors.

3. The method of claim 2, further comprising:
generating, using the feature engineering technique, a plurality of production data feature vectors from the production data files,
wherein the production related similarity score is generated by applying the machine learning algorithm to the plurality of production data feature vectors.

4. The method of claim 1, further comprising:
generating, based at least on the aggregate similarity score of said each pair of wells, a plurality of well clusters,
wherein each of the plurality of well clusters corresponds to an analogous portion of the field.

5. The method of claim 4,
wherein the plurality of well clusters is further generated based on inter-well spacing and well connectivity estimate.

6. The method of claim 4, further comprising:
generating, based at least on the plurality of well clusters, a machine learning model of the field performance; and
generating, using at least the machine learning model, a production performance evaluation result of the wells and respective contributions to overall performance of the field.

7. The method of claim 6, further comprising:
initiating or adjusting, in response to a user viewing the production performance evaluation result, the field operation.

8. A data gathering and analysis system, comprising:
a computer processor; and
memory storing instructions, when executed, causing the computer processor to:
generate, based on well log data files of the wells, a geology related similarity score for each pair of wells with respect to a well log depth range of a plurality of well log depth ranges;
generate, based on production data files of the wells, a production related similarity score for said each pair of wells with respect to a production time stamp range of a plurality of production time stamp ranges;
generate, by combining the geology related similarity score and the production related similarity score, a combined similarity score of said each pair of wells with respect to the well log depth range and the production time stamp range;
generate, by aggregating the combined similarity score of said each pair of wells with respect to the plurality of well log depth ranges and the plurality of production time stamp ranges, an aggregate similarity score of said each pair of wells; and
facilitate, based at least on the aggregate similarity score of said each pair of wells, the field operation in the field.

9. The data gathering and analysis system of claim 8, the instructions, when executed, further causing the computer processor to:
generate, using a feature engineering technique, a plurality of well log feature vectors from the well log data files,
wherein the geology related similarity score is generated by applying a machine learning algorithm to the plurality of well log feature vectors.

10. The data gathering and analysis system of claim 9, the instructions, when executed, further causing the computer processor to:
generate, using the feature engineering technique, a plurality of production data feature vectors from the production data files,
wherein the production related similarity score is generated by applying the machine learning algorithm to the plurality of production data feature vectors.

11. The data gathering and analysis system of claim 8, the instructions, when executed, further causing the computer processor to:
generate, based at least on the aggregate similarity score of said each pair of wells, a plurality of well clusters,
wherein each of the plurality of well clusters corresponds to an analogous portion of the field.

12. The data gathering and analysis system of claim 11,
wherein the plurality of well clusters is further generated based on inter-well spacing and well connectivity estimate.

13. The data gathering and analysis system of claim 11, the instructions, when executed, further causing the computer processor to:
generate, based at least on the plurality of well clusters, a machine learning model of the field performance; and
generate, using at least the machine learning model, a production performance evaluation result of the wells and respective contributions to overall performance of the field.

14. The data gathering and analysis system of claim 13, the instructions, when executed, further causing the computer processor to:
initiate or adjust, in response to a user viewing the production performance evaluation result, the field operation.

15. A system comprising:
a plurality of wells penetrating a subterranean formation in a field; and
a data gathering and analysis system comprising functionality for:
generating, based on well log data files of the wells, a geology related similarity score for each pair of wells with respect to a well log depth range of a plurality of well log depth ranges;
generating, based on production data files of the wells, a production related similarity score for said each pair of wells with respect to a production time stamp range of a plurality of production time stamp ranges;
generating, by combining the geology related similarity score and the production related similarity score, a combined similarity score of said each pair of wells with respect to the well log depth range and the production time stamp range;
generating, by aggregating the combined similarity score of said each pair of wells with respect to the plurality of well log depth ranges and the plurality of production time stamp ranges, an aggregate similarity score of said each pair of wells; and
facilitating, based at least on the aggregate similarity score of said each pair of wells, the field operation in the field.

16. The system of claim 15, the data gathering and analysis system further comprising functionality for:
generating, using a feature engineering technique, a plurality of well log feature vectors from the well log data files,
wherein the geology related similarity score is generated by applying a machine learning algorithm to the plurality of well log feature vectors.

17. The system of claim 16, the data gathering and analysis system further comprising functionality for:
generating, using the feature engineering technique, a plurality of production data feature vectors from the production data files,
wherein the production related similarity score is generated by applying the machine learning algorithm to the plurality of production data feature vectors.

18. The system of claim 15, the data gathering and analysis system further comprising functionality for:
generating, based at least on the aggregate similarity score of said each pair of wells, a plurality of well clusters,
wherein each of the plurality of well clusters corresponds to an analogous portion of the field.

19. The system of claim 18,
wherein the plurality of well clusters is further generated based on inter-well spacing and well connectivity estimate.

20. The system of claim 18, the data gathering and analysis system further comprising functionality for:
generating, based at least on the plurality of well clusters, a machine learning model of the field performance;
generating, using at least the machine learning model, a production performance evaluation result of the wells and respective contributions to overall performance of the field; and
initiating or adjusting, in response to a user viewing the production performance evaluation result, the field operation.
